(19) United States
(12) Patent Application Publication
(10) Pub. No.: US 2026/0231918 A1
(43) Pub. Date: Aug. 13, 2026

(54) JIG HEAD WITH SWIVEL

(71) Applicant: Pure Fishing, Inc., Spirit Lake, IA (US)

(72) Inventors: Daniel Eric Spengler, Milford, IA (US); Kyle Jacob Peterson, Spirit Lake, IA (US)

(21) Appl. No.: 19/533,876

(22) Filed: Feb. 9, 2026

Related U.S. Application Data
(60) Provisional application No. 63/756,499, filed on Feb. 10, 2025.

(51) Int. Cl. A01K 85/00; A01K 85/10

(52) U.S. Cl. CPC A01K 85/1833; A01K 85/10

(57) ABSTRACT

A jig for a slow death fishing technique and/or casting applications includes a partially embedded swivel that controls movement of a hook connected to the swivel. The partially embedded swivel can reduce the risk of the fishing line becoming tangled which may allow the jig to be casted. Casting the jig can widen the potential positions of the jig in the water column. The swivel may also be positioned in a cavity or recess to further reduce exposure of the swivel to the fishing line and otherwise control movement of the hook during trolling, drifting, etc. and/or casting. In some embodiments, the jig may include a jig head that is configured (e.g., shaped or contoured) to control or optimize water flowing past the jig.

### CROSS REFERENCE TO RELATED APPLICATIONS

This application claims priority to U.S. Provisional Patent Application No. 63/756,499, filed Feb. 10, 2025, the entire contents of which are incorporated herein by reference.

### TECHNICAL FIELD

The present disclosure relates generally to jig heads usable with moveable or rotatable fishing hooks.

### BACKGROUND

The “slow death” technique is a fishing technique that can be used in trolling or drifting applications. The slow death technique is designed to entice fish to the bait, typically live bait such as a worm or nightcrawler, via a particular motion or movement of the bait during trolling. For example, a slow death jig and hook may cooperate to slowly spin or rotate the bait to entice bites as the jig, hook, and bait are drawn through the water. Configuring the jig and hook for the slow death motion can create the risk of tangling the line. As a result, the slow death jig and hook may only allow limited movement or rotation of the bait and/or may be designed for limited or no casting. The limits on casting are caused by tangling in the air and tumbling in the water column while trying to reach a target depth. Other drawbacks may include inadequate movement or rotation of the bait to achieve the desired enticing slow death motion during trolling and/or a bulky design that can further lead to tangling the line.

A need exists for a castable jig that can enable desired movement or rotation of the bait, e.g., for a slow death technique, while also reducing or eliminating the risk of tangling.

### SUMMARY

The present disclosure provides a jig that can be used in a slow death fishing technique during trolling and/or in casting applications. The jig may include a jig head having a swivel and a tail eyelet connected to the swivel, where the tail eyelet facilitates connecting a hook to the jig head. The swivel may advantageously be partially embedded in the jig head to allow maximum rotation with minimal risk of line tangling. The jig may thereby be castable to maximize the positioning of the jig in the water column. The jig head may be configured (e.g., shaped or contoured) for controlling or optimizing the water flowing past the jig, e.g., during trolling or reeling, to cause movement, e.g., slow death movement, of the hook. In some embodiments, the jig may include a blade connected between the tail eyelet and the hook. In some embodiments, the swivel may be at least partially positioned in a cavity or recess that can further reduce the exposure risks of the swivel to the fishing line. The cavity or recess can also limit the range of movement of the tail eyelet for controlled movement during trolling, drifting, etc. and/or casting. The cavity or recess may also reduce fouling on the swivel and/or tail eyelet.

Some embodiments provide a jig for a slow death fishing technique and/or casting applications, the jig including a jig head, a head eyelet, a tail eyelet, and a swivel. The jig head has a first end and a second end. The head eyelet is positioned at the first end of the jig head for tying a fishing line to the jig head. The tail eyelet is positioned at the second end of the jig head for connecting a hook and/or a blade to the jig head. The swivel is positioned at the second end of the jig head, the tail eyelet being connected to the swivel, the swivel allowing rotation of the tail eyelet relative to the jig head, the swivel having an embedded portion in the jig head.

In some embodiments, the tail eyelet is connected to the swivel via an anchoring member.

In some embodiments, the anchoring member includes an anchor arm extending from an anchoring shaft into the embedded portion, and an offset arm connecting the head eyelet to the anchoring shaft.

In some embodiments, the anchoring shaft is substantially parallel to a rotational axis defined by the swivel.

In some embodiments, the offset arm extends across a rotational axis defined by the swivel.

In some embodiments, the offset arm extends diagonally from the anchoring shaft.

In some embodiments, a rotational axis defined by the swivel extends between the head eyelet and a center of mass of the jig head.

In some embodiments, the jig head has a curved nose at the first end.

In some embodiments, the curved nose is between a rotational axis defined by the swivel extends and the head eyelet.

In some embodiments, the embedded portion is non-rotatably mounted in the jig head, and the swivel has an exposed portion rotatably engaged with the embedded portion.

In some embodiments, the exposed portion extends beyond the jig head.

In some embodiments, the exposed portion is disposed within a recess defined by the jig head.

In some embodiments, the recess is defined by a substantially cylindrical internal wall.

In some embodiments, the jig head defines opposing curved recesses, and a rotational axis defined by the swivel is between the curved recesses.

In some embodiments, a blade including a hook is connected to the swivel.

Some embodiments provide a fishing jig that includes a swivel, a body, a head eyelet, and an anchoring member. The swivel is mounted in the body. The swivel defines a rotational axis. The head eyelet extends from the body. The anchoring member is disposed in the body and connects the swivel to the head eyelet. The rotational axis extends between the head eyelet and a center of mass of the body.

In some embodiments, the anchoring member rotationally fixes an embedded portion of the swivel relative to the body.

In some embodiments, the anchoring member includes an anchoring shaft connected to an anchor arm and an offset arm, the offset arm extends diagonally from the anchoring shaft and connects to the head eyelet, the anchor arm connects to the swivel, and the offset arm and the anchor arm traverse the rotational axis.

Some embodiments provide a fishing jig that includes a swivel, a jig head, and a head eyelet. The swivel has an embedded portion rotationally fixed in the jig head. The swivel defines a rotational axis. The head eyelet extends from the jig head. The rotational axis extends between the head eyelet and a center of mass of the jig. A curved nose of the jig head is located between the rotational axis and the head eyelet.

In some embodiments, the jig head defines a recess, and an exposed portion of the swivel is disposed within the recess.

The following description and the appended figures set forth certain features for purposes of illustration. Advantages will become more apparent when reading the present disclosure in its entirety.

### BRIEF DESCRIPTION OF DRAWINGS

So that the manner where the above recited features may be understood in detail, a more particular description, briefly summarized above, may be had by reference to example aspects, some of which are illustrated in the appended drawings.

FIG. 1 is a side elevation of a first example jig;

FIG. 2 is a side elevation of the jig of FIG. 1, with internal components thereof illustrated in phantom;

FIG. 3 is a front view of the jig of FIG. 1;

FIG. 4 is a front view of the jig of FIG. 1, with the internal components of FIG. 2 illustrated in phantom;

FIG. 5 is a rear view of the jig of FIG. 1;

FIG. 6 is a rear view of the jig of FIG. 1, with the internal components of FIG. 2 illustrated in phantom;

FIG. 7 is a perspective view of a second example jig;

FIG. 8 is a side elevation view of the jig of FIG. 7;

FIG. 9 is another perspective view of the jig of FIG. 7;

FIG. 10 is perspective view of a jig head of the jig of FIG. 7;

FIG. 11 is a side elevation view of the jig head of FIG. 10 with internal components thereof illustrated in phantom;

FIG. 12 is a top plan view of the jig head of FIG. 10, with the internal components of FIG. 11 illustrated in phantom;

FIG. 13 is a rear view of the jig head of FIG. 10, with the internal components of FIG. 11 illustrated in phantom;

FIG. 14 is a side elevation view of the jig head of FIG. 10; and

FIG. 15 is a top plan view of the jig head of FIG. 10.

Corresponding reference numbers in the drawings indicate corresponding parts.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

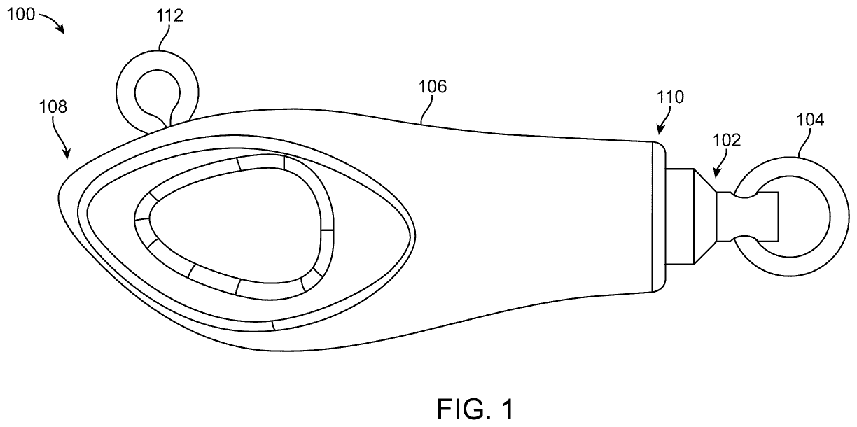

FIG. 1 depicts a jig 100 that can be used in slow death fishing techniques for a trolling application and/or in casting applications. The jig 100 has a partially embedded swivel 102 operably coupled to a tail eyelet 104 that connects to a hook (not shown) such as a slow death hook. The swivel 102 allows rotation of the eyelet 104 and the hook relative to a body 106 of the jig 100. During movement of the jig 100 in the water, such as during drifting, trolling, or casting, bait such as an earthworm or night crawler that is rigged on the hook can rotate via the swivel 102, which may entice bites on the bait. The partially embedded swivel 102 reduces the size and/or exposure of the moving joints of the jig 100 to the fishing line (not shown), which may reduce the risk of tangling the line. The partially embedded swivel 102 can also reduce the size and footprint of the jig 100, which may further reduce tangling risks. The swivel 102 may also be in close proximity with the body 106 of the jig 100, and the body can be designed to optimize water flowing past the jig 100 for creating the desired motion of the swivel 102 and the bait, e.g., desired slow death motion. The jig 100 may also be castable, which can widen the potential positions the jig 100 can have in the water column. In this way, the jig 100 can have improved usability and greater versality in slow death trolling applications and/or casting applications and provide a more enjoyable experience for the angler.

The body 106, or jig head, of the jig 100 may include a first end or a head 108 and a second end or a tail 110. The swivel 102 may be positioned at or proximate the tail 110. A head eyelet 112 may be positioned proximate the head 108. The head eyelet 112 may be offset from the tail eyelet 104. For example, the tail eyelet 104 may be substantially aligned with a longitudinal center of the body 106 and the head eyelet 112 may be offset from the longitudinal center and positioned towards a side or top of the body. The head eyelet 112 may be fixed or non-rotatable relative to the body 106. The fishing line may be tied to the jig 100 via the head eyelet 112. The center of mass of the body 106 may be proximate the head 108. In some embodiments, a majority of the mass of the body 106 may be beside or under the head eyelet 112. This may align the mass of the body 106 relative to the pull point at the head eyelet 112 and enable proper orientation of the jig 100 in the body of water and/or during movement in the body of water.

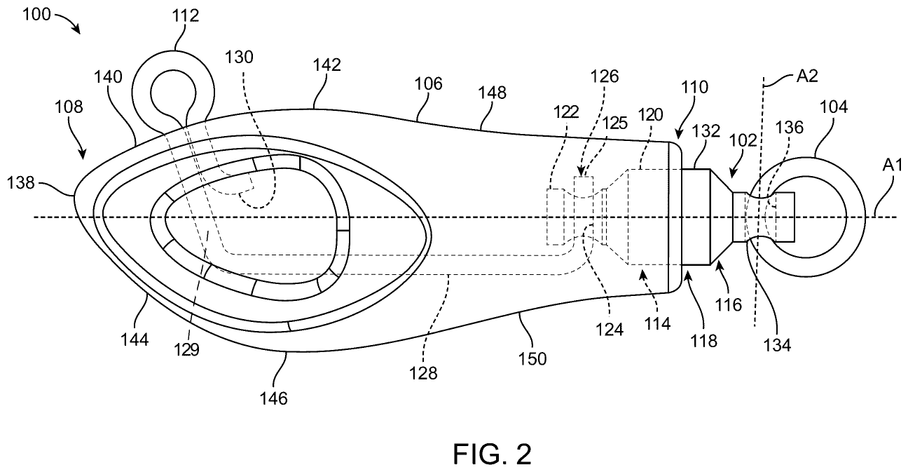

Referring to FIG. 2, the swivel 102 may include an embedded portion 114 and an exposed portion 116. The embedded portion 114 may be positioned or embedded within the body 106 proximate the tail 110. The exposed portion 116 may extended outward from the tail 110 and is operably coupled to the tail eyelet 104. The exposed portion 116 may be rotatably coupled to the embedded portion 114 via a swivel or rotating joint 118. The rotating joint 118 may allow the exposed portion 116 to rotate relative to the embedded portion 114 and the body 106 about a rotational axis A1. The exposed portion 116 may also be referred to as a rotating portion. The embedded portion 114 may be fixed relative to the body 106. The embedded portion 114 may also be referred to as a fixed portion or a non-rotating portion.

The embedded portion 114 may include an embedded base 120 and an embedded pin 122 extending from the base 120 towards the head 108 of the body 106. The embedded base 120 may partially define the rotating joint 118. The embedded pin 122 may be fixed relative to the embedded base 120. The embedded pin 122 may include a center bore 124 that receives an anchor arm 125 of an anchoring member 126. The anchoring member 126 may fix the embedded pin 122 within the body 106. In this example, the anchoring member 126 is securely positioned in the center bore 124 of the embedded pin 122 to fix or anchor the embedded portion 114 in the body 106. In other examples the embedded portion 114 may be fixed or anchored in the body 106 using any suitable anchoring, fixing, or attachment means which may be connected to the embedded pin 122 and/or the embedded base 120.

The anchoring member 126 in this embodiment may include an anchoring shaft 128 that extends in the body 106 between the head eyelet 112 and the embedded pin 122. More specifically, an offset arm 129 connects the head eyelet 112 to the anchoring shaft 128. Further, in some embodiments, the anchoring shaft 128 is offset and/or parallel to the rotational axis A1. In some embodiments, the anchor arm 125 extends substantially orthogonally from the anchoring shaft 128 and/or across the rotational axis A1. In some embodiments, the offset arm 129 extends diagonally from the anchoring shaft 128 and/or across the rotational axis A1. The offset arm 129 is longer than the anchor arm 125. Thus, the anchoring shaft 128 may connect the head eyelet 112 and the embedded portion 114. Each of the head eyelet 112 and the embedded portion 114 may be fixed, anchored, and/or non-rotatable relative to the body 106 via the anchoring shaft 128. The head eyelet 112 may include an additional anchoring member 130 that fixes or anchors the head eyelet 112 to the body 106. In some embodiments, the head eyelet 112 and the embedded portion 114 may be fixed, anchored, and/or non-rotatable relative to the body 106 via separate anchoring means or other attachments.

The exposed portion 116 may include an exposed base 132 extending rearwardly from the tail 110 and an exposed pin 134 extending rearwardly from the base 132. The exposed base 132 may partially define the rotating joint 118 with the embedded base 132. The exposed pin 134 may be fixed relative to the exposed base 132 such that the exposed base and pin co-rotate relative to the body 106 about the rotational axis A1. The exposed pin 134 may include a center bore 136 that receives the tail eyelet 104. The tail eyelet 104 may be moveable, e.g., via swinging, pivoting or oscillating movement, within the center bore 136 relative to the exposed pin 134. For example, the tail eyelet 104 may pivot, oscillate, or swing about an axis A2. The axis A2 may be substantially perpendicular to the rotational axis A1 of the exposed portion 116.

The exposed base 132 and the exposed pin 134 may also be referred to as the rotating base and the rotating pin, and the embedded base 120 and the embedded pin 122 may also be referred to as the fixed or non-rotating base and fixed or non-rotating pin.

In some embodiments, the hook (not shown) connected the tail eyelet 104 may have at least two degrees of motion: 360 degree rotation via the swivel 102 relative to the body 106 about the rotational axis A1 and movement such as swinging, pivoting or oscillation via the tail eyelet 104 relative to the swivel about the axis A2. The axis A2 may follow the rotation about the rotational axis A1. For example, as the exposed portion 116 rotates about the rotational axis A1, the angular position of the center bore 136 and the tail eyelet 104 relative to the body 106 changes as does the axis A2 while the axis A2 remains substantially perpendicular to the rotational axis A1. The tail eyelet 104 may also be moveable circumferentially with the center bore 136 and/or the hook may be slidable along the tail eyelet 104. In this way, the hook and the bait rigged on the hook can have a wide range of movements during trolling, drifting, etc. that may be desirable to entice bites on the bait.

The rotational axis A1 may be aligned with the longitudinal center of the body 106 and the tail eyelet 104. The head eyelet 112 may be offset from the rotational axis A1. For example, as shown in FIG. 2, the head eyelet 112 may be located above the rotational axis A1. The body 106 may include a curved contour between the longitudinal center and the head eyelet 112. The head eyelet 112 may be positioned at an oblique angle relative to the longitudinal center and the rotational axis A1. The center of mass of the body 106 may be aligned or proximate the longitudinal center and the rotational axis A1 or may be offset from the longitudinal center and the rotational axis A1. For example, the center of mass of the body 106 may be offset from and below the rotational axis A1. The position and location of the head eyelet 112 and the center of mass of the body 106 may cooperate to orient and stabilize the jig 100 during trolling, drifting, etc. The orientation of the jig 100 may desirable or suitably position the head 108 of the body 106 for tracking. The orientation of the jig 100 may desirably or suitably position the moving tail eyelet 104, hook, and bait to entice bites on the bait. In embodiments, the position and location of the head eyelet 112 and the center mass of the body 106 may allow casting and can desirably or suitably orient the jig 100 in the water column when cast. Casting the jig 100 can also be facilitated while reducing the risk of line tangling via the partially embedded swivel 102.

The head eyelet 112 may be positioned on a front region of the head 108. The head 108 may also include contours that may facilitate optimal or desirable water flow past the body 106 during trolling, drifting, etc. For example, the head 108 may include a curved nose 138 below the head eyelet 112. The curved nose 138 may define a front tip of the body 106. The body 106 may include curved surfaces extending rearwardly from the curved nose 138 towards the tail 110. A top curved surface 140 may extend to an apex or crown 142 of the body 106. The head eyelet 112 may be positioned on the top curved surface 140. A bottom curved surface 144 may extend to a bottom or belly 146 of the body 106. The apex 142 and the bottom 146 may respectively define high and low points of the body 106 such that a width or girth of the body 106 is greatest between the apex and the bottom. Rear curved surfaces 148, 150 may respectively extend from the apex 142 and the bottom 146 towards the tail 110 such that the width or girth of the body 106 gradually tapers towards the tail 110. The apex 142 and the bottom 146 may be positioned towards the head 108 such that the center of mass of the body 106 is proximate the head 108. The bottom 146 may also be located farther away from the longitudinal center of the body 106 and the rotational axis A1 than the apex 142 such that the center of mass is below the longitudinal center and the rotational axis A1.

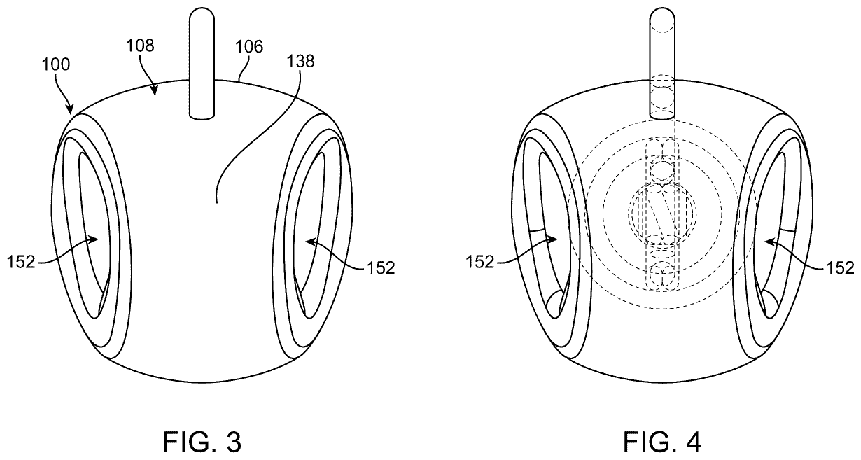

Referring to FIG. 3, the head 108 may include recesses 152 on opposite sides of the nose 138. FIG. 4 depicts a contour of the recesses 152 in lined detail. The recesses 152 may delineate or define regions on the head 108 where decorative features or indicia, such as three-dimensional eyes adhered to the head 108, may be positioned.

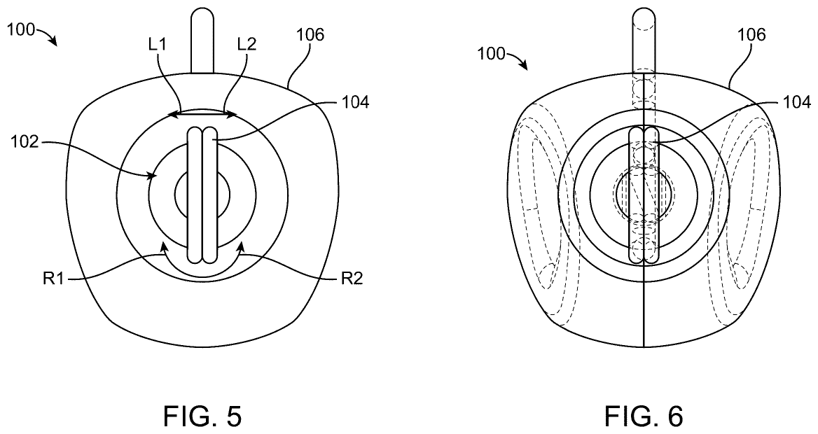

Referring to FIG. 5, the tail eyelet 104 may move via the swivel 102 and relative to the body 106 in various directions. For example, the tail eyelet 104 can rotate 360 degrees in a first rotational direction R1, which may be the clockwise direction in this view. The tail eyelet 104 may also rotate 360 degrees in a second rotational direction R2, which may be the counterclockwise direction in this view. The tail eyelet 104 additionally or alternatively may swing, pivot or oscillate in the lateral directions L1 and L2 relative to the body 106. As discussed above, the lateral directions L1 and L2 relative to the body 106 may change during rotation of the tail eyelet 104 in the rotational directions R1 and R2. Movement of the tail eyelet 104 may translate to movement of the hook and the rigged bait to provide a wide range of movements during trolling that may be desirable to entice bites on the bait. In some embodiments, movement of the tail eyelet 104 may allow slow death movement of the hook and the bait.

Referring to FIG. 6, the contours of the body 106 of the jig 100 may facilitate optimal or desirable water flow past the body 106. In some embodiments, the body 106 may be contoured to facilitate movement, e.g., slow death movement, of the tail eyelet 104, the hook, and the bait via the water flowing past the body. The water may flow past the body 106 during trolling, drifting, or other movement of the jig 100 in the body of water.

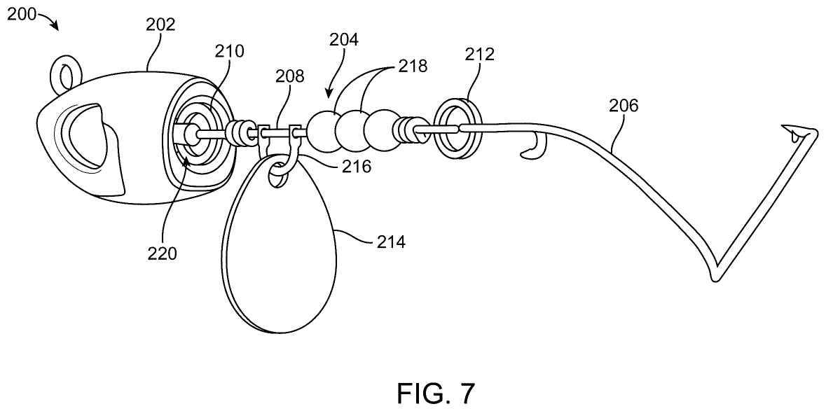

Referring now to FIG. 7, a second example jig 200 that can be used in slow death fishing techniques for a trolling application and/or in casting applications is shown. The jig 200 in this example includes a jig head 202, or body, and a blade 204 extending rearwardly from the jig head 202. The jig head 202 may be similarly configured as the body 106 described above, and the functions and advantages of the jig 100 may similarly be applicable to the jig 200. The blade 204 may be included to further entice bites on a hook 206 connected to the blade 204. For example, the blade 204 may include visual or audial features that can attract fish to the jig 200. The blade 204 may additionally or alternatively position or orient the jig 200 in the water column. The jig 200 including the blade 204 may be referred to as a bladed version of a jig.

In this example, the blade 204 may include an elongate member or shaft 208 extending between a tail eyelet 210 of the jig head 202 and a blade eyelet 212. The shaft 208 may be moveably connected to the jig head 202 via the tail eyelet 210 and the hook 206 may be movably connected to the shaft 208 via the blade eyelet 212. A swinging fob 214 may be connected to the shaft 208 via a horseshoe bracket 216. The bracket 216 may rotate about the shaft 208 and the fob 214 may swing from the bracket 216 to allow a wide range of movement of the fob 214 during trolling. The blade 204 may also include bells or balls 218 moveable or slidable along the shaft 208. During trolling, the swing fob 214 and the balls 218 may create flash, noise, or other sensory perceptions that can attract fish to the jig 200.

In some embodiments, the hook 206 may be configured, e.g., shaped, for the slow death technique. For example, the hook may be bent in a corkscrew or semi-helical shape. The shape of the hook 206 may complement slow death movement of the hook during trolling, drifting, etc. to entice bites on the hook. The hook 206 may be moveable with the blade 204 relative to the jig head 202. The hook 206 may also be moveable relative to the blade 204 via the blade eyelet 212. The hook 206 may be referred to as a slow death hook in some examples.

The blade 204 may be connected to a partially embedded swivel 220 of the jig head 202 via the tail eyelet 210. The swivel 220 may enable rotation of the tail eyelet 210, the blade 204, and the hook 206. In some embodiments, the swivel 220 may be configured similarly to the swivel 102 described above.

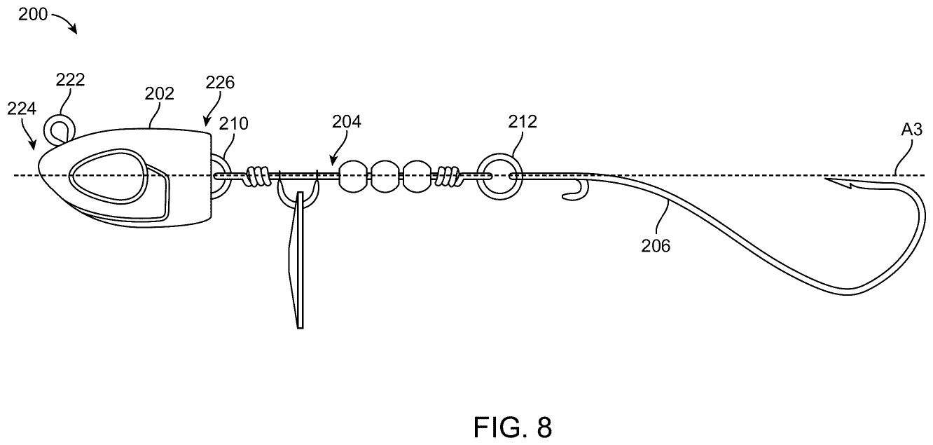

Referring to FIG. 8, the tail eyelet 210, the blade 204, and the hook 206 may rotate about a rotational axis A3 via the swivel 220. The blade 204 may swing, pivot, or oscillate relative to the swivel 220 via the tail eyelet 210 and/or the hook 206 may swing, pivot, or oscillate relative to the blade 204 via the blade eyelet 212. In this way, the hook 206 and the bait rigged on the hook can have a wide range of movements during trolling that may be desirable to entice bites on the bait. In some embodiments, the movement of the tail eyelet 210, the blade 204, and the hook 206 may allow slow death movement of the bait rigged on the hook 206 to entice baits on the bait.

The jig head 202 may also include a head eyelet 222 positioned proximate a head end 224 of the jig head. The head end 224 may be opposite a tail end 226 where the tail eyelet 210 is located. Similar to the head eyelet 112 described above, the head eyelet 222 may be offset from the tail eyelet 210 and the rotational axis A3. For example, the head eyelet 222 may be offset from the rotational axis A3 and positioned towards a side or top of the jig head 202. The head eyelet 222 may be fixed or non-rotatable relative to the jig head 202. The fishing line (not shown) may be tied to the jig head 202 via the head eyelet 222. Like the body 106 described above, the center of mass of the jig head 202 and the position of the head eyelet 222 may cooperate to stabilize and orient the jig 200 during trolling, drifting, etc.

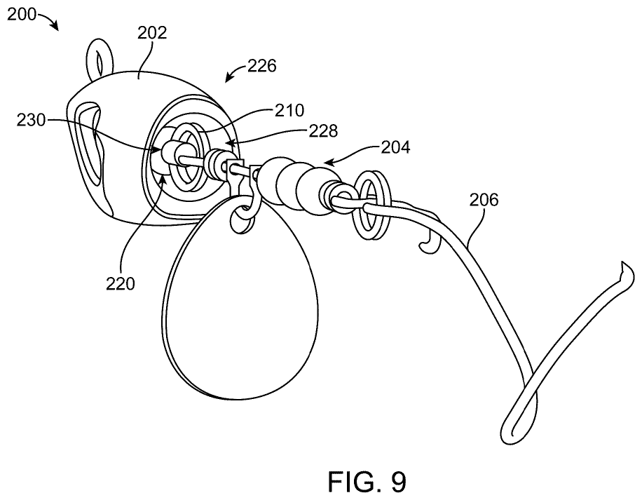

Referring to FIG. 9, in this example, the jig head 202 may be truncated at the tail end 226. The jig head 202 may include a recess or cavity 228 at the tail end 226. An exposed portion 230 of the swivel 220 may be surrounded by the recess or cavity 228. As can be gleaned from FIG. 8, in some examples, the exposed portion 230 of the swivel 220 may be entirely surrounded by the recess or cavity 228. A portion of the tail eyelet 210 may also be surrounded by the recess or cavity 228. In some examples, the tail eyelet 210 may be entirely surrounded by the recess or cavity 228.

The exposed portion 230 of the swivel 220, and in some examples the tail eyelet 210, being at least partially positioned in the recess or cavity 228 may facilitate reducing the risk of tangling the line. For example, the tail end 226 of the jig head 202 may shield the swivel 220 and at least a portion of the tail eyelet 210 from the fishing line. Additionally or alternatively, positioning the tail eyelet 210 at least partially in the recess or cavity 228 may limit or prevent the range of motion of the tail eyelet 210 to reduce the risk of tangling the line. For example, the tail eyelet 210 may be limited or restricted in swinging, pivoting, or oscillating relative to the swivel 220 within the recess or cavity 228. This can limit or prevent large lateral deviations of the blade 204 and the hook 206 relative to the jig head 202 that could otherwise create the risk of line tangling. The controlled movement of the tail eyelet 210, the blade 204, and the hook 206 may additionally or alternatively center the hook relative to the rotational axis during trolling, drifting, etc. The controlled movement of the tail eyelet 210, the blade 204, and the hook 206 may facilitate slow death movement in some embodiments. The controlled movement of the tail eyelet 210, the blade 204, and the hook 206 may additionally or alternatively allow the jig 200 to be casted while reducing the risk of tangling the line. In some embodiments, positioning the swivel 220 in the cavity 228 may also reduce the risk of fouling.

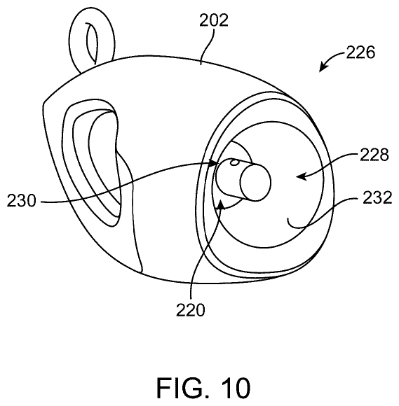

Referring to FIG. 10, the cavity 228 at the tail end 226 of the jig head 202 may define an internal wall 232 that surrounds the exposed portion 230 of the swivel 220. The internal wall 232 may interfere with the range of movement of the tail eyelet 210 (omitted in FIG. 10) for controlling movement as discussed above. In some embodiments, the internal wall 232 may be cylindrical in shape.

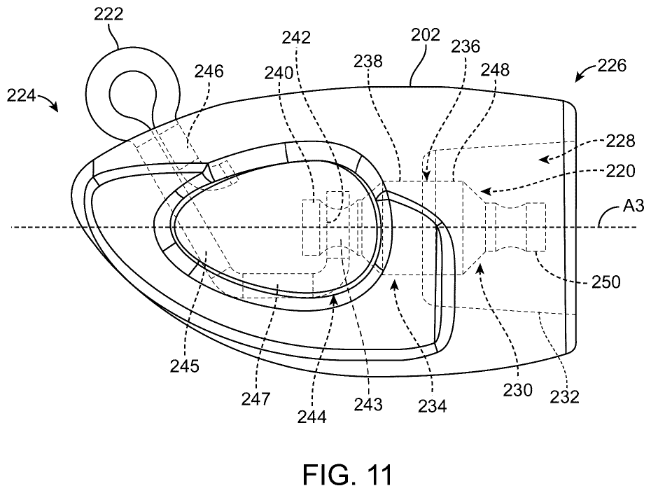

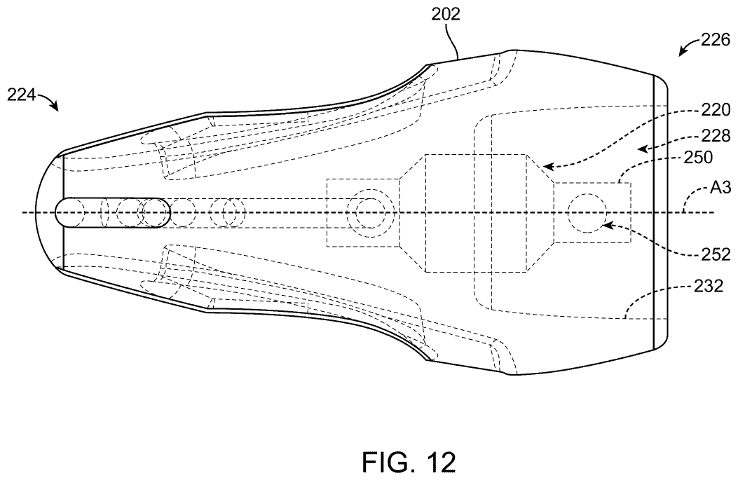

Referring to FIG. 11, the swivel 220 may include the exposed portion 230 positioned in the cavity 228 and an embedded portion 234 in the jig head 202. The exposed portion 230, also referred to as a rotating portion, may be configured similar to the exposed portion 116 of the swivel 102. The embedded portion 234, also referred to as a fixed portion or a non-rotating portion, may be configured similar to the embedded portion 114 of the swivel 102. The exposed portion 230 may rotate about the rotational axis A3 relative to the embedded portion 234 via a swivel or rotating joint 236.

The embedded portion 234 may include an embedded base 238 and an embedded pin 240 extending from the base 238 towards the head end 224 of the jig head 202. The embedded base 238 may partially define the rotating joint 236. The embedded pin 240 may be fixed relative to the embedded base 238. The embedded pin 240 may include a center bore 242 that receives an anchor arm 243 of an anchoring member 244. The anchoring member 244 may fix the embedded pin 240 within the jig head 202. In this example, the anchoring member 244 is securely positioned in the center bore 242 of the embedded pin 240 to fix or anchor the embedded portion 234 in the jig head 202. In other examples the embedded portion 234 may be fixed or anchored in the jig head 202 using any suitable anchoring, fixing, or attachment means which may be connected to the embedded pin 240 and/or the embedded base 238.

The anchoring member 244 in this embodiment may be similar to the anchoring member 126 described above. The anchoring member 244 may extend in the jig head 202 between the head eyelet 222 and the embedded pin 240. More specifically, an offset arm 245 connects the head eyelet 222 to an anchoring shaft 247. Further, in some embodiments, the anchoring shaft 247 is offset and/or parallel to the rotational axis A3. In some embodiments, the anchor arm 243 extends substantially orthogonally from the anchoring shaft 247 and/or across the rotational axis A3. In some embodiments, the offset arm 245 extends diagonally from the anchoring shaft 247 and/or across the rotational axis A3. The offset arm 245 is longer than the anchor arm 243. Thus, the anchoring member 244 may connect the head eyelet 222 and the embedded portion 234. Each of the head eyelet 222 and the embedded portion 234 may be fixed, anchored, and/or non-rotatable relative to the jig head 202 via the anchoring member 244. The head eyelet 222 may include an additional anchoring member 246 that fixes or anchors the head eyelet 222 to the jig head 202. In some embodiments, the head eyelet 222 and the embedded portion 234 may be fixed, anchored, and/or non-rotatable relative to the jig head 202 via separate anchoring means or other attachments.

The exposed portion 230 of the swivel 220 may include an exposed base 248 and an exposed pin 250 extending rearwardly from the base 248. Each of the exposed base 248 and the exposed pin 250 may be positioned in the cavity 228. In some examples, the exposed pin 250 may at least partially extend outward beyond the cavity 228. The exposed base 248 and the exposed pin 250 may also be referred to as the rotating base and the rotating pin, and the embedded base 238 and the embedded pin 240 may also be referred to as the fixed or non-rotating base and fixed or non-rotating pin. The exposed base 248 may partially define the rotating joint 236 with the embedded base 238. The exposed pin 250 may be fixed relative to the exposed base 248 such that the exposed base and pin co-rotate relative to the jig head 202 about the rotational axis A3.

Referring to FIG. 11, the exposed pin 250 of the swivel 220 may include a center bore 252 that receives the tail eyelet 210 (omitted from FIG. 11). The tail eyelet 210 (shown in FIG. 9) may be moveable, e.g., via swinging, pivoting or oscillating movement, within the center bore 252 relative to the exposed pin 250. For example, the tail eyelet may pivot, oscillate, or swing about an axis that may be substantially perpendicular to the rotational axis A3 of the swivel 220. As discussed above, the internal wall 232 of the cavity 228 may limit or restrict movement of the tail eyelet relative to the swivel 220 which may allow for controlled movement, e.g., slow death movement. The internal wall 232 may limit or restrict movement of the tail eyelet during trolling, drifting, or other movement of the jig 200 in the body of water and/or during casting of the jig 200.

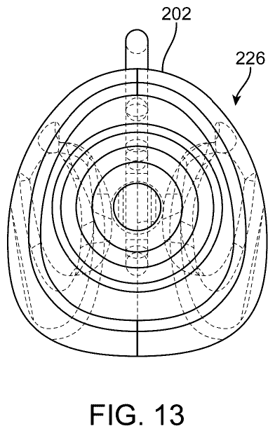

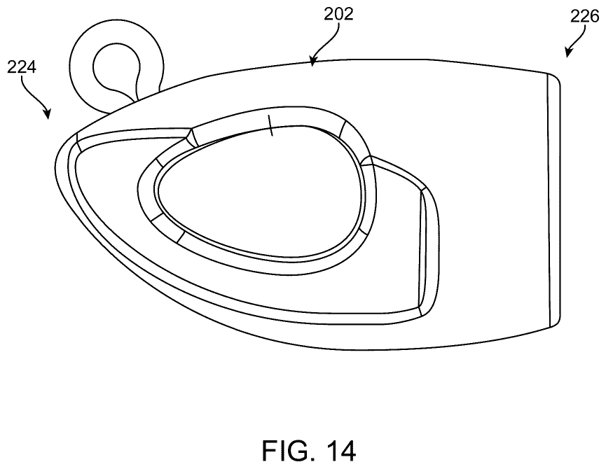

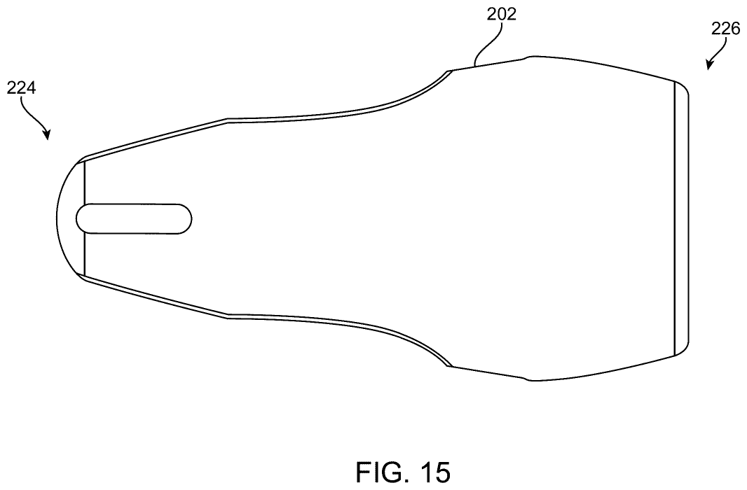

Referring generally to FIGS. 10-15, the jig head 202 may have a curved contour between the head end 224 and the tail end 226. The contour of the jig head 202 may be designed to control or optimize water flowing past the jig head for creating the desired motion of the swivel 220 and the bait. For example, the contour of the jig head 202 may control or optimize water flowing past the jig head for creating slow death movement of the swivel 220 and the bait. In some embodiments, the jig head 202 may be shaped similar to the body 106 of the jig 100 described above, except the jig head 202 may be truncated at the tail end 226 where the cavity 228 is formed.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, references to “one embodiment” or “an embodiment” of the present disclosure are not intended to be interpreted as excluding the existence of additional embodiments that also incorporate the recited features.

Unless specified or limited otherwise, the terms “mounted,” “connected,” “supported,” and “coupled” and variations thereof are used broadly and encompass both direct and indirect mountings, connections, supports, and couplings.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

As used herein, the term “comprising” is considered synonymous with the term “including” for purposes of United States law. Whenever a composition, an element or a group of elements is preceded with the transitional phrase “comprising,” it is understood that the transitional phrases “consisting essentially of,” “consisting of,” “selected from the group of consisting of,” or “is” can additionally or alternatively precede the recitation of the composition, element, or elements and vice versa.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A jig for a slow death fishing technique and/or casting applications, the jig comprising:
a jig head having a first end and a second end;
a head eyelet positioned at the first end of the jig head for tying a fishing line to the jig head;
a tail eyelet positioned at the second end of the jig head for connecting a hook and/or a blade to the jig head; and
a swivel positioned at the second end of the jig head, the tail eyelet being connected to the swivel, the swivel allowing rotation of the tail eyelet relative to the jig head, the swivel having an embedded portion in the jig head.

2. The jig of claim 1, wherein the tail eyelet is connected to the swivel via an anchoring member.

3. The jig of claim 2, wherein the anchoring member includes
an anchor arm extending from an anchoring shaft into the embedded portion, and
an offset arm connecting the head eyelet to the anchoring shaft.

4. The jig of claim 3, wherein the anchoring shaft is substantially parallel to a rotational axis defined by the swivel.

5. The jig of claim 3, wherein the offset arm extends across a rotational axis defined by the swivel.

6. The jig of claim 3, wherein the offset arm extends diagonally from the anchoring shaft.

7. The jig of claim 1, wherein a rotational axis defined by the swivel extends between the head eyelet and a center of mass of the jig head.

8. The jig of claim 1, wherein the jig head has a curved nose at the first end.

9. The jig of claim 8, wherein the curved nose is between a rotational axis defined by the swivel extends and the head eyelet.

10. The jig of claim 1, wherein
the embedded portion is non-rotatably mounted in the jig head, and
the swivel has an exposed portion rotatably engaged with the embedded portion.

11. The jig of claim 10, wherein the exposed portion extends beyond the jig head.

12. The jig of claim 10, wherein the exposed portion is disposed within a recess defined by the jig head.

13. The jig of claim 12, wherein the recess is defined by a substantially cylindrical internal wall.

14. The jig of claim 1, wherein
the jig head defines opposing curved recesses, and
a rotational axis defined by the swivel is between the curved recesses.

15. The jig of claim 1, wherein a blade including a hook is connected to the swivel.

16. A fishing jig, comprising:
a swivel mounted in a body, the swivel defining a rotational axis;
a head eyelet extending from the body; and
an anchoring member disposed in the body and connecting the swivel to the head eyelet, wherein
the rotational axis extends between the head eyelet and a center of mass of the body.

17. The fishing jig of claim 16, wherein the anchoring member rotationally fixes an embedded portion of the swivel relative to the body.

18. The fishing jig of claim 16, wherein
the anchoring member includes an anchoring shaft connected to an anchor arm and an offset arm,
the offset arm extends diagonally from the anchoring shaft and connects to the head eyelet,
the anchor arm connects to the swivel, and
the offset arm and the anchor arm traverse the rotational axis.

19. A fishing jig, comprising:
a swivel having an embedded portion rotationally fixed in a jig head, the swivel defining a rotational axis; and
a head eyelet extending from the jig head, wherein
the rotational axis extends between the head eyelet and a center of mass of the jig, and
a curved nose of the jig head is located between the rotational axis and the head eyelet.

20. The fishing jig of claim 19, wherein
the jig head defines a recess, and
an exposed portion of the swivel is disposed within the recess.
